(19) United States
(12) Patent Application Publication
(10) Pub. No.: US 2008/0164778 A1
(43) Pub. Date: Jul. 10, 2008

(54) Magnetic motor

(76) Inventor: Steven James Schieffer, Sioux Falls, SD (US)

Correspondence Address: THOMTE LAW OFFICE, L.L.C., 2120 S. 72ND STREET, SUITE 1111, OMAHA, NE, 68124, US

(21) Appl. No.: 11/986,930

(22) Filed: Nov. 27, 2007

Related U.S. Application Data
(60) Provisional application No. 60/878,550, filed on Jan. 4, 2007.

(51) Int. Cl. H02K 37/00

(52) U.S. Cl. 310/152; 310/48; 310/46

(57) ABSTRACT

A magnetic motor which includes an elongated, horizontally disposed frame having a drive shaft rotatably mounted therein with the drive shaft being supported at its opposite ends by titanium bearing blocks. Opposing first and second slide panels having bar magnets at the inner surfaces thereof are movably mounted on the frame and are movable towards the drive shaft which has magnets mounted thereon in a helical fashion. As the slide panels with the magnets thereon are moved towards the drive shaft, the magnets on the slide panels will cause the magnets on the drive shaft to be repelled thereby causing the rotation of the drive shaft. Movement of the slide panels is controlled by actuators.

### CROSS-REFERENCE TO RELATED APPLICATION

This application claims the benefit of U.S. Provisional Application Ser. No. 60/878,550 entitled “MARS MOTOR” filed Jan. 4, 2007, the disclosure of which is hereby incorporated herein by reference.

### BACKGROUND OF THE INVENTION

1. Field of the Invention

This invention relates to a magnetic motor and more particularly to a magnetic motor which employs titanium roller bearings at the opposite ends of a drive shaft which allows for high stress power demands at both ends of the motor. Further, this invention relates to a magnetic motor which is preferably horizontally disposed in comparison to some other magnetic motors that are vertically disposed.

2. Description of the Related Art

Many types of magnetic motors have been previously provided but most of the magnetic motors with which applicant is familiar are vertically disposed rather than horizontally disposed which makes it difficult to use in a conventional vehicle, boat, etc. Further, the magnetic motors of the prior art are not believed to have titanium roller bearings at opposite ends of the drive shaft which enables a motor to be extremely durable and powerful. Additionally, the vertically disposed magnetic motors of the prior art do not provide for convenient power applications from opposite ends of the drive shaft. Additionally, the prior art is believed to contain an extremely large number of component parts which are difficult to assemble and which are difficult to maintain. Additionally, the prior art magnetic motors are not believed to be as powerful as required.

### SUMMARY OF THE INVENTION

A magnetic motor is described which includes an elongated hollow-like frame means which has first and second ends. The frame means has first and second bearings positioned at the first and second ends thereof which are preferably constructed of titanium. An elongated first slide panel, having inner and outer sides and first and second ends, is operatively movably secured to the frame means and is positioned therein. An elongated second slide panel, having inner and outer sides and first and second ends, is also operatively movably secured to the frame means and is positioned therein opposite to the first slide panel. Each of the first and second slide panels has a semi-circular cross-section. A first actuator is secured to and extends between the frame means and the first slide panel with the first actuator adapted to move the first slide panel between a first outer position to a second inner position. A second actuator is secured to and extends between the frame means and the second slide panel and is adapted to move the second slide panel between a first outer position to a second inner position. The magnetic motor also includes an elongated drive shaft having first and second ends with its first and second ends being rotatably mounted in the first and second bearings, respectively. A plurality of first elongated magnet supports, having first and second ends, are secured at their first ends to the drive shaft and extend outwardly therefrom. The first magnet supports are secured to the drive shaft in a helical fashion with respect thereto. A plate-like magnet is secured to each of the second ends of the first magnet supports. A plurality of first elongated magnet bars are secured to the inner surface of the first slide panel with each of the first magnet bars having a planar outer surface. A plurality of second elongated magnet bars are secured to the inner surface of the second slide panel with each of the second magnet bars having a planar outer surface. The magnet bars extend between the first and second ends of the slide panels with the longitudinal axes thereof being parallel to the longitudinal axis of the drive shaft.

The polarity of the magnet bars on the first and second slide panels and the plate-like magnets are such that the plate-like magnets on the magnet supports are repelled by the magnet bars on the slide panels thereby causing the drive shaft to be rotated with respect to the frame means when the first and second actuators move the first and second slide panels from their first outer position towards their second inner position and towards the plate-like magnets on the magnet supports on the drive shaft. The first and second ends of the drive shaft have adapters thereon for connection to a member requiring rotational movement.

In a second embodiment of the invention, the first and second slide panels do not have the elongated magnet bars secured to the inner surface thereof but the first and second slide panels have a semi-circular magnet positioned at the inner surface thereof with the semi-circular magnets having the same general configuration as the slide panels. In the second embodiment, the polarity of the semi-circular magnets on the first and second slide panels and the plate-like magnets on the magnet supports on the drive shaft is such that the plate-like magnets are repelled by the semi-circular magnets thereby causing the drive shaft to be rotated with respect to the frame means when the first and second actuators move the first and second slide panels from their first outer position towards their second inner position and towards said plate-like magnets on the drive shaft. The frame means is preferably enclosed by a suitable casing, housing or cover.

It is therefore a principal object of the invention to provide an improved magnetic motor.

Still another object of the invention is to provide an improved magnetic motor wherein the elongated drive shaft thereof is horizontally disposed rather than vertically disposed.

Yet another object of the invention is to provide a magnetic motor wherein the horizontally disposed drive shaft has adapters at the opposite ends thereof which are adapted to be connected to members requiring rotational movement.

Yet another object of the invention is to provide a magnetic motor of the type described which includes a horizontally disposed drive shaft which is supported on a frame means by a pair of titanium bearings at the opposite ends of the drive shaft.

Still another object of the invention is to provide a magnetic motor wherein the opposing magnets thereof may be easily replaced should the need require.

Still another object of the invention is to provide a magnetic motor which includes a pair of actuators which are operatively connected to a pair of slide panels which have magnets thereon and which are movable between a rotatable drive shaft which has a plurality of magnets secured thereto and extending therefrom which are arranged in a helical fashion with respect to the drive shaft.

Still another object of the invention is to provide a magnetic motor which is constructed so as to be able to incorporate lubrication systems.

A further object of the invention is to provide a magnetic motor which is adapted to have air filtration systems associated therewith.

Yet another object of the invention is to provide a magnetic motor wherein the rotation of the drive shaft is controlled by the movement of a pair of slide panels mounted on opposite sides thereof with the slide panels having magnets mounted thereon and with the slide panels being movable towards and away from the magnets on the drive shaft so as to control the rotation of the drive shaft.

Still another object of the invention is to provide a magnetic motor which may be fabricated in almost any size depending upon the power requirements thereof.

Yet another object of the invention is to provide a magnetic motor wherein movement of a pair of semi-circular slide panels towards a drive shaft having magnets thereon will cause the drive shaft to be rotated.

These and other objects will be apparent to those skilled in the art.

### BRIEF DESCRIPTION OF THE DRAWINGS

FIG. 1 is a perspective view of the magnetic motor of this invention;

FIG. 2 is a sectional view of the magnetic motor of FIG. 1;

FIG. 3 is a view similar to FIG. 2 except that the view illustrates a bearing at one end of the drive shaft;

FIG. 4 is a partial sectional view illustrating the relationship of the magnets on the drive shaft and the magnets on the slide panels with the broken lines illustrating the manner in which the drive shaft is rotated by the magnets on the slide panels;

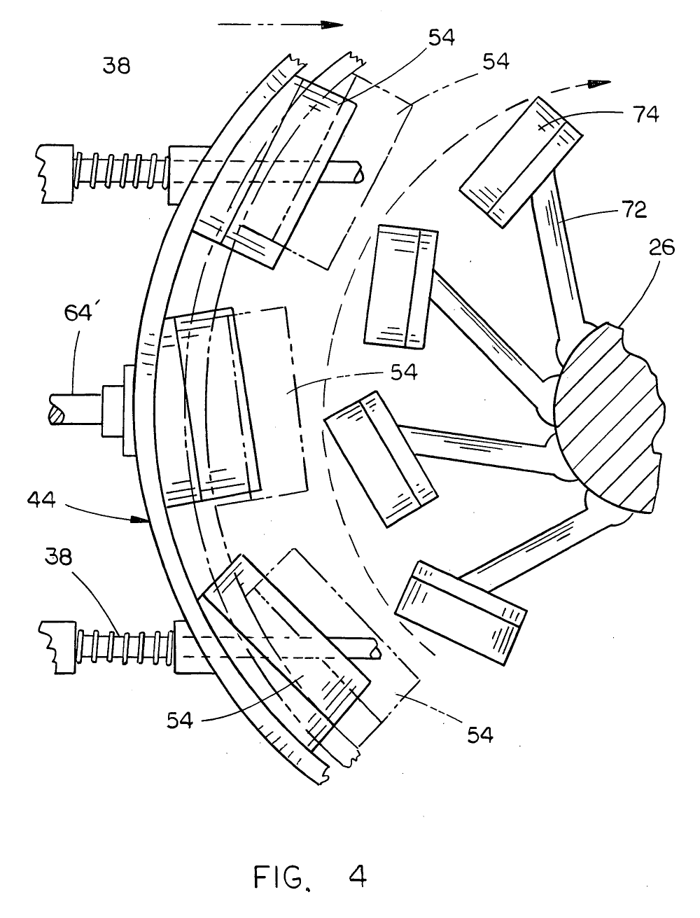

FIG. 5 is a partial perspective view of the drive shaft having a plurality of magnet supports secured thereto in a helical fashion with a plurality of magnets being secured to the magnet supports;

FIG. 6 is a partial top view of one of the drive shaft mounted in a dual bearing with portions thereof removed to more fully illustrate the invention;

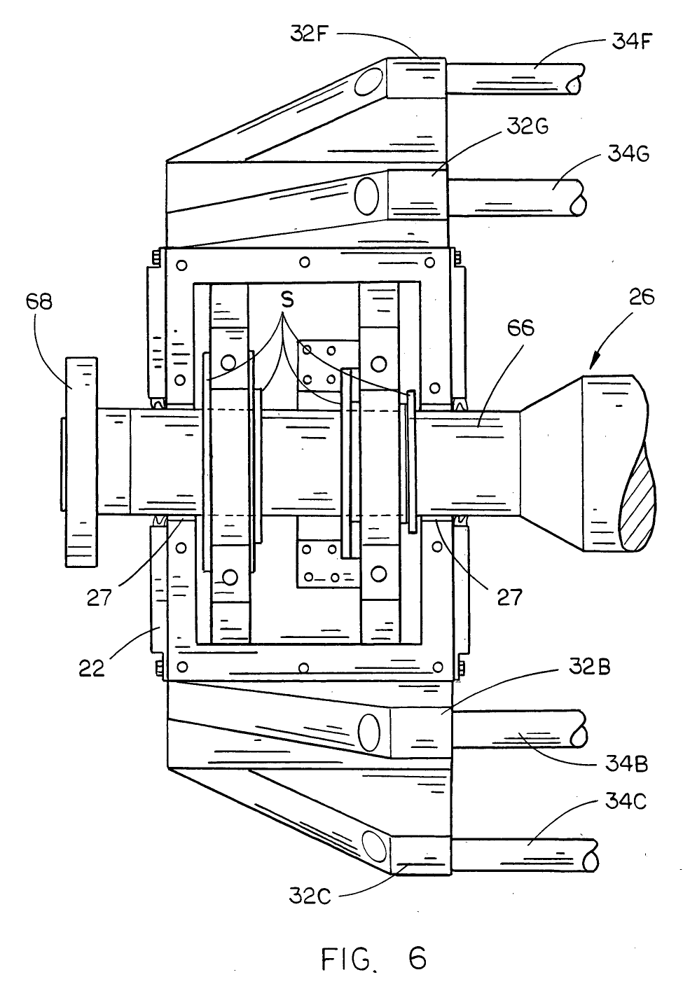

FIG. 7 is a partial exploded perspective view illustrating the manner in which one end of the drive shaft is received in one-half of a bearing;

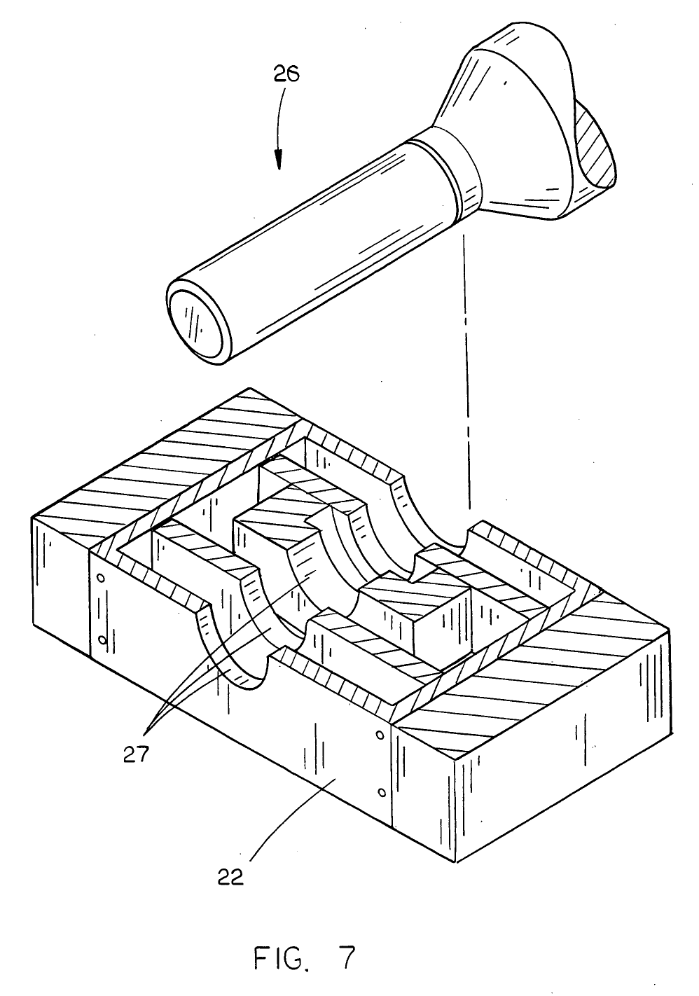

FIG. 8 is a side elevational view of the magnetic motor of this invention;

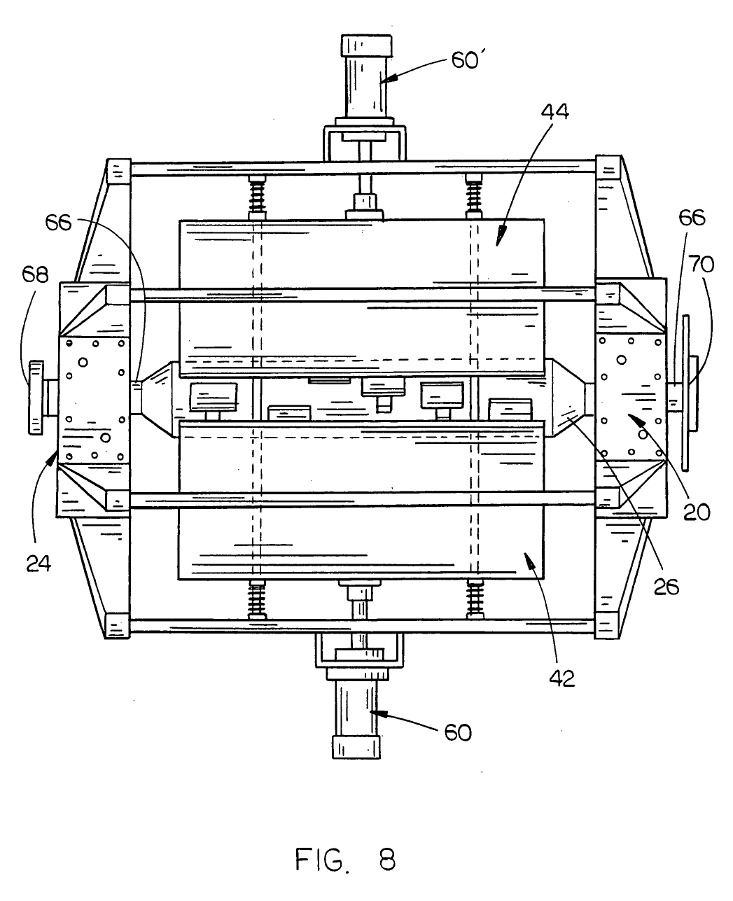

FIG. 9 is an exploded perspective view of one of the slide panels of the invention which has a plurality of spaced-apart elongated magnet bars removably secured thereto; and

FIG. 10 is a sectional view illustrating a second embodiment of the invention wherein the magnet bars on the inside surfaces of the slide panels have been replaced with semi-circular magnets.

### DETAILED DESCRIPTION OF THE INVENTION

The magnetic motor of this invention is generally designated by the reference numeral 10 and is seen to be elongated. Motor 10 includes a frame means 12 which will normally be enclosed in a housing, casing or cover. Frame means 12 has ends 14 and 16 for purposes of description.

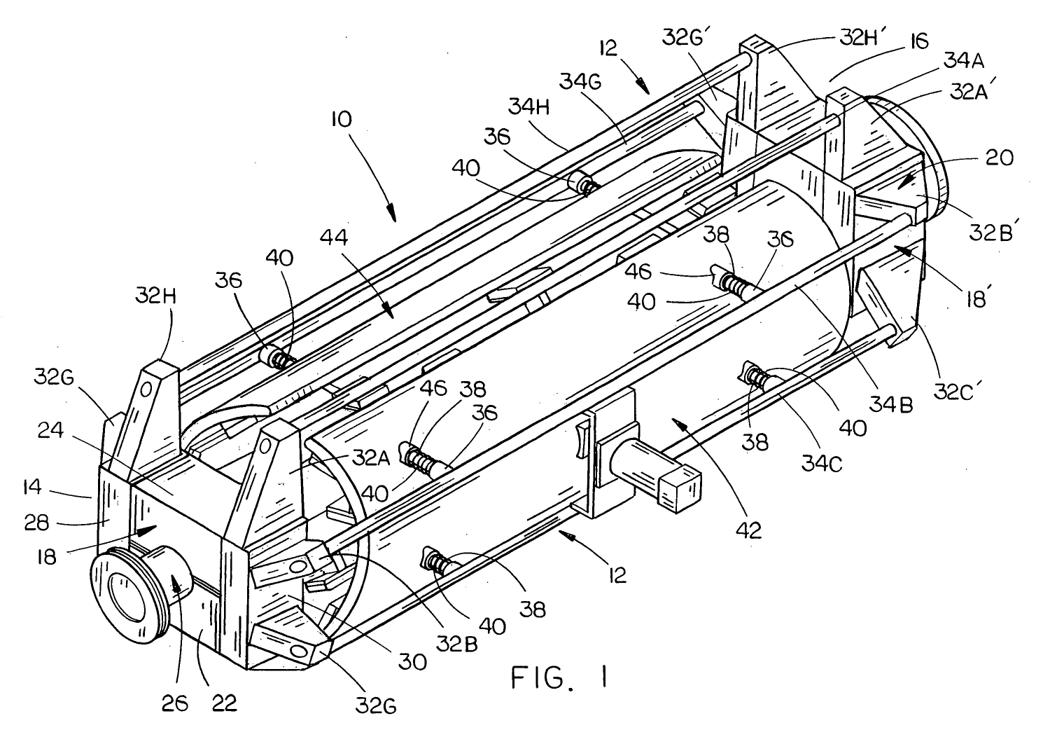

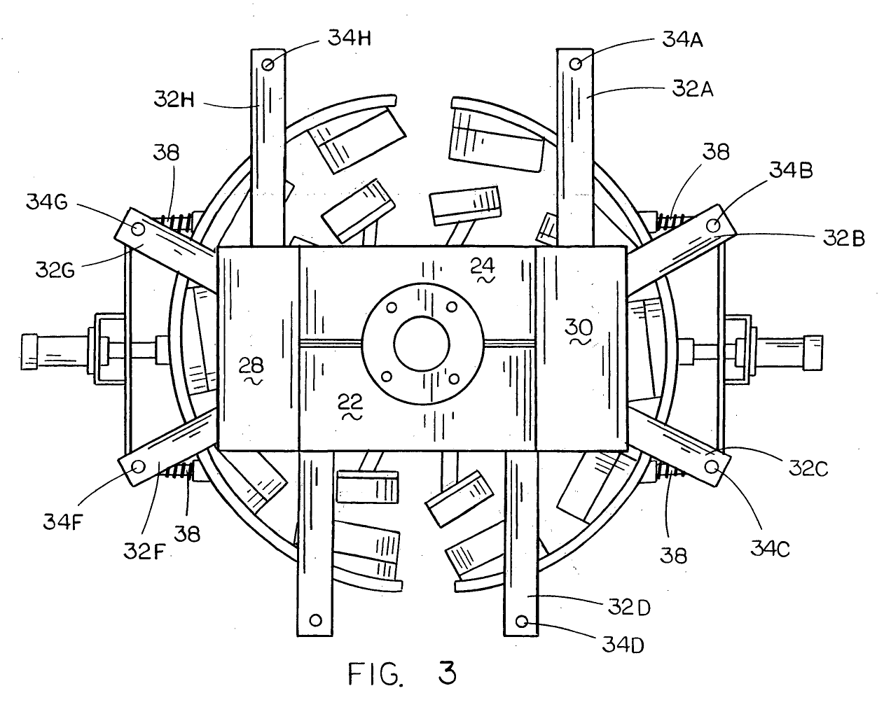

The longitudinal axis of the motor 10 is preferably horizontally disposed as opposed to the vertically disposed prior art magnetic motors. The frame means 12 has a support means 18 at end 14 and a support means 20 at end 16. Support means 18 includes bearing blocks 22 and 24 with the bearing blocks 22 and 24 being preferably comprised of titanium. Bearing blocks 22 and 24 could be a one-piece casting. Each of the bearing blocks 22 and 24 includes a plurality of semi-circular recesses 27 formed therein which are adapted to receive one end of a drive shaft 26 therein with certain of the semi-circular recesses 27 being adapted to receive oil seals or snap rings S therein. Support blocks 28 and 30 are secured to the opposite sides of bearing blocks 22 and 24 by any convenient means such as bolts or the like with the support blocks 28 and 30 having a plurality of rod supports 32A-32H secured thereto and extending therefrom, as best illustrated in FIGS. 1 and 3. The support blocks 28 and 30 are secured to the bearing blocks 22 and 24 by any convenient means such as bolts, cap screws or the like. Support blocks 28 and 30 may also be cast with the bearing blocks 22 and 24. Similarly, a support means 18′ is provided at the other end of the frame means 12 and is identical to the support means 18 just described. For purposes of conciseness, similar structure on support means 18′ that is found on support means 18 will be designated with the designation “′”.

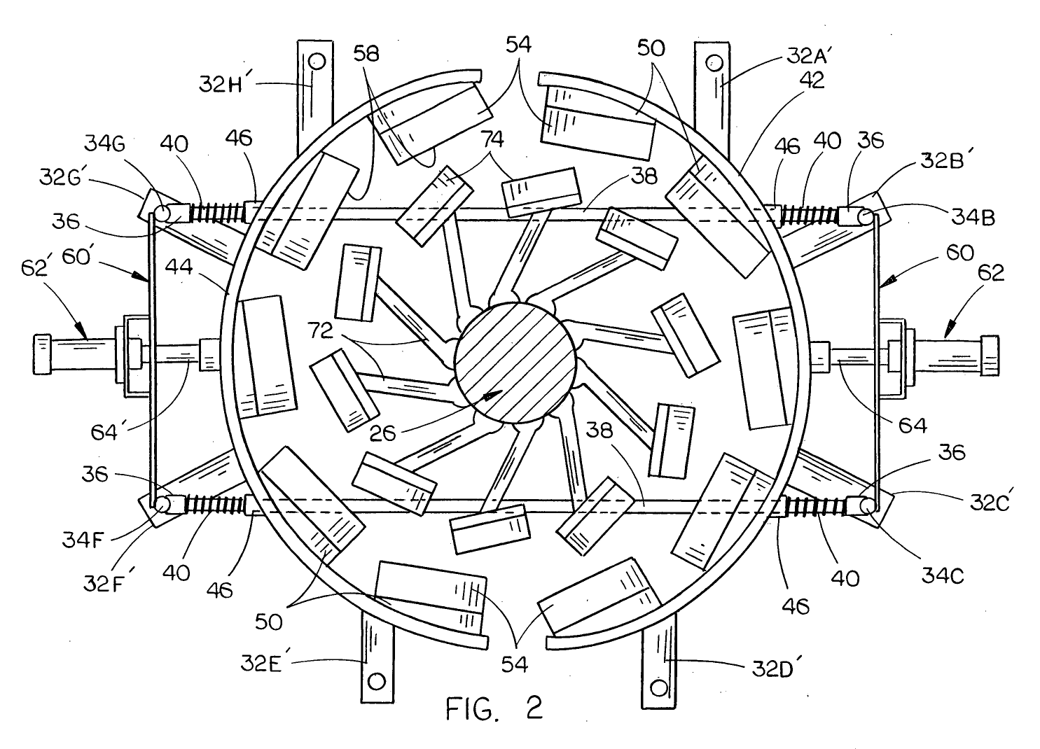

A plurality of elongated rods 34A-G are secured to the supports 32 and 32′ and extend therebetween, as best illustrated in FIGS. 1 and 3. Rods 34B and 34C and rods 34F and 34G have tubular stubs 36 secured thereto by welding or the like which extend inwardly therefrom. Rods 38 extend transversely across the frame means 12 and have their opposite ends received in the stubs 36, as illustrated in FIG. 2. Springs 40 are mounted on the opposite ends of the rods 38, as illustrated in FIG. 2, and act as shock absorbers as will be described in more detail hereinafter.

The numeral 42 refers to a first semi-circular slide panel positioned in frame means 12 and which extends substantially the entire length of the frame means 12, as illustrated in FIG. 1. The numeral 44 refers to an elongated semi-circular slide panel which is positioned within the frame means 12 and which is positioned opposite to slide panel 42. The rods 38 slidably extend through tubular members 46 in slide panel 42 and through the tubular members 46 in slide panel 44, as best illustrated in FIGS. 1 and 2. As seen in FIG. 2, the springs 40 are positioned outwardly of the small tubular members 46.

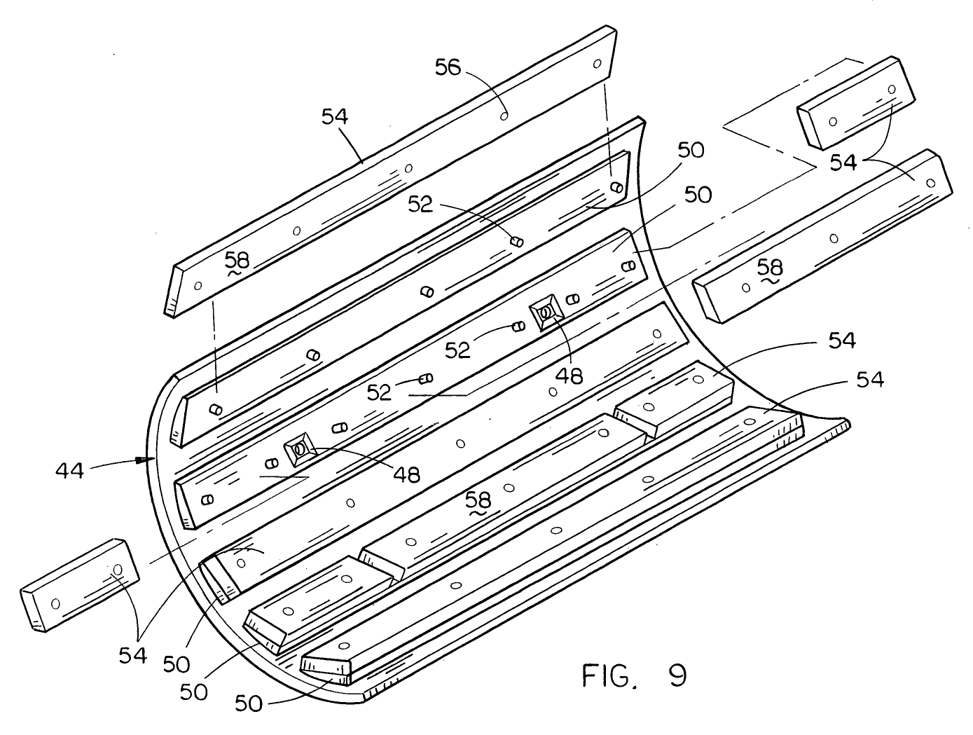

Each of the slide panels 42 and 44 have a plurality of longitudinally extending support members 50 radially spaced-apart and secured thereto. Each of the support members 50 have a plurality of spaced-apart pegs 52 extending therefrom. Two of the support members 50 have the openings 48 formed therein which communicate with tubular members 46 to permit the rods 38 to extend therethrough. A plurality of bar magnets 54 having openings 56 formed in the outer side thereof are snap-fitted onto the pegs 52 of support members 50, as illustrated in FIG. 9. Each of the bar magnets 54 have a planar outer surface 58. In those locations where the rods 38 extend through the slide panel and the support members, three spaced-apart bar magnets are employed rather than one continuous bar magnet to enable the rods 38 to extend therethrough.

Actuator supports 60 and 60′ are secured to rods 34B, 34C and 34F, G, respectively, as best illustrated in FIG. 2, and have actuators 62 and 62′ mounted thereon with the plungers 64 and 64′ thereof being connected to the respective slide panel. The actuators 62 may be electrical actuators, screw actuators, pneumatic actuators or even manual actuators if the motor is of the small variety. In any case, the extension of the plungers 64 and 64′ cause the slide panels 42 and 44 to move inwardly with respect to the frame means 12 with the retraction of plunger 64 causing the slide panels 42 and 44 to move towards the actuator. As seen in FIG. 2, the planar inner face 58 of the bar magnets 54 are angularly disposed with respect to the curvature of the slide panels. In other words, the bar magnets planar faces 58 are not tangentially positioned with respect to the slide panels.

The drive shaft 26 is positioned in the interior of the frame means 12 between the slide panels 42 and 44 with its end portions 66 being rotatably mounted in the bearings 22 and 24, respectively. Adapters 68 and 70 are operatively secured to the outer ends of end portions 66 of the drive shaft 26 and which may be connected to members requiring rotational movement.

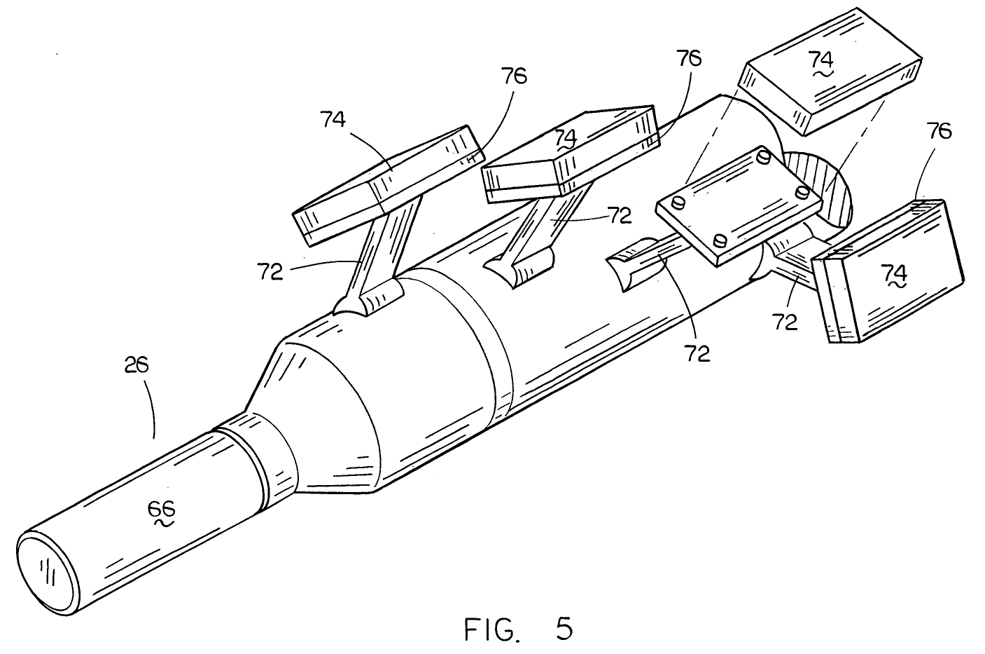

Referring to FIG. 5, the numerals 72 refer to elongated magnet supports, the inner ends of which are secured to the drive shaft 26 and which extend at an angular relationship outwardly therefrom. The magnet supports 72 are arranged on the exterior surface of the drive shaft 26 in a multiple helical fashion. A plate-like magnet 74 is secured to each of the outer ends 76 of supports 72 in the same manner as the magnets 54 are secured to the support members 50, as previously described. The planar outer faces of the magnets 74 are disposed at an angle with respect to the longitudinal axis of the supports 72 so as to be disposed at an angle with respect to the planar outer faces 58 of the magnets 54, as best illustrated in FIG. 2. Although the shape of the magnets 74 is preferably that as shown and described, the magnets 74 could have other shapes.

The entire assembly just described, with the exception of the adapters 68 and 70, will normally be enclosed in a housing, casing, cover or the like which may be vented to supply cooling air thereinto. Further, a suitable lubrication means may be included in the structure to provide oil to the bearings 22 and 24.

The magnets 58 and 74 are preferably comprised of a neodymium material or a samarium cobalt material.

Further, the motor may require a braking mechanism to halt the rotation of the drive shaft 26.

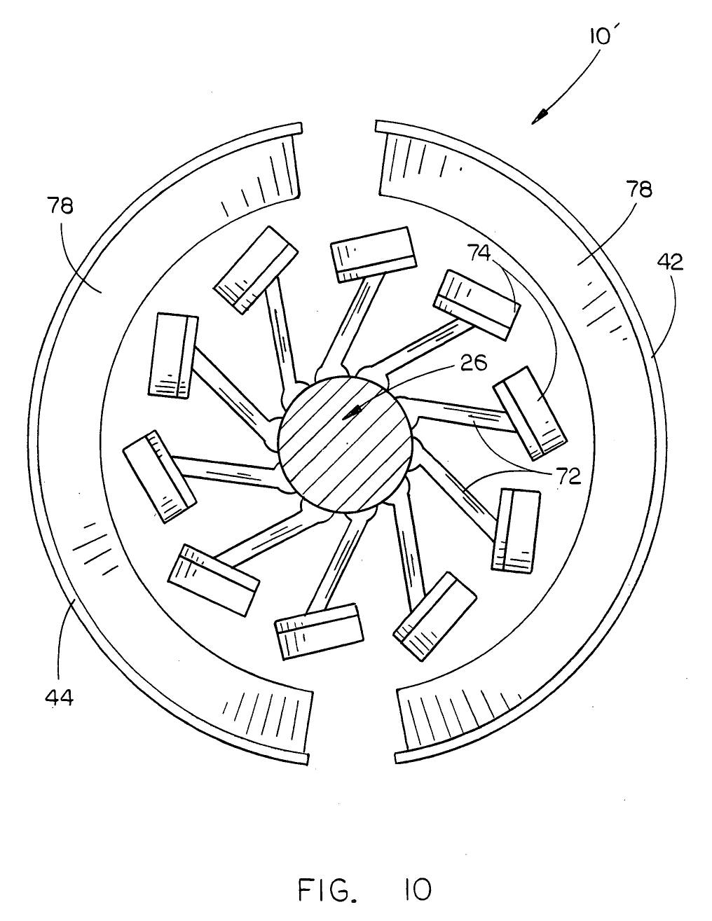

FIG. 10 illustrates a modified form of the invention with the only difference between the device 10′ in FIG. 10 and that previously described is that the spaced-apart bar magnets 58 in device 10 are not included with those magnets being substituted by a pair of elongated, semi-circular magnets 78.

In operation, the plungers 64 and 64′ of the actuators 62 and 62′ will be in their retracted positions so that the slide panels 42 and 44 are in their outermost position. In that position, there will normally not be sufficient repelling action between the bar magnets 54 and the magnet 74 to cause the shaft 26 to rotate. However, if rotation of the drive shaft 26 does occur when the slide panels 42 and 44 are in their outermost position, some form of braking mechanism will be used to prevent the drive shaft from rotating.

When it is desired to actuate the magnetic motor 10 of this invention, the actuators 62 and 62′ will be actuated to cause the plungers 64 and 64′ to move the slide panels 42 and 44 from their outermost position towards their innermost position. As the slide panels 42 and 44 move inwardly, the repelling forces between the magnets 54 and the magnet 74 will cause the magnet 74 to move away from the angled magnets 54 which will cause the rotation of the drive shaft 26. The rotational speed of the drive shaft 26 will be increased as the slide panels 42 and 44 are moved to their innermost position.

To slow or stop the motor, the actuators 62 and 62′ are operated so that the plungers 64 and 64′ thereof are withdrawn into the actuators which will cause the slide panels 42 and 44 to move away from the drive shaft, thereby reducing the repelling forces between the magnets 74 and 54. The springs 40 act as a shock absorber as the slide panels are moved from their innermost to their outermost positions.

Thus it can be seen that the invention accomplishes at least all of its stated objectives.

I claim:

1. A magnetic motor, comprising:
an elongated hollow frame means having first and second ends;
a first bearing positioned at said first end of said frame means;
a second bearing positioned at said second end of said frame means;
an elongated first slide panel, having inner and outer sides and first and second ends, operatively movably secured to said frame means and positioned therein;
an elongated second slide panel, having inner and outer sides and first and second ends, operatively movable secured to said frame means and positioned therein opposite to said first slide panel;
each of said slide panels having a semi-circular cross-section;
a first actuator secured to and extending between said frame means and said first slide panel;
said first actuator adapted to move said first slide panel between a first outer position to a second inner position;
a second actuator secured to and extending between said frame means and said second slide panel;
said second actuator adapted to move said second slide panel between a first outer position to a second inner position;
an elongated drive shaft having first and second ends;
said drive shaft having its first and second ends rotatably mounted in said first and second bearings, respectively;
a plurality of first elongated magnet supports having first and second ends;
said first magnet supports being secured at their said first ends to said drive shaft and extending outwardly therefrom;
said first magnet supports being secured to said drive shaft in a helical fashion with respect thereto;
a magnet secured to each of said second ends of said first magnet supports;
a plurality of first elongated magnet bars secured to said inner surface of said first slide panel;
each of said first magnet bars having an outer surface;
a plurality of second elongated magnet bars secured to said inner surface of said second slide panel;
each of said second magnet bars having an outer surface;
said magnet bars extending between said first and second ends of said slide panels with the longitudinal axes thereof being parallel to the longitudinal axis of said drive shaft;
the polarity of said magnet bars on said first and second slide panels and said magnets on said magnet supports being such that said magnets on said magnet supports are repelled by said magnet bars thereby causing said drive shaft to be rotated with respect to said frame means when said first and second actuators move said first and second slide panels from their said first outer position towards their said second inner position and towards said plate-like magnets on said drive shaft.

2. The magnetic motor of claim 1 wherein said first end of said drive shaft has an adapter thereon for connection to a member requiring rotational movement.

3. The magnetic motor of claim 1 wherein said second end of said drive shaft has an adapter thereon for connection to a member requiring rotational movement.

4. The magnetic motor of claim 1 wherein each of said first and second ends of said drive shaft has an adapter thereon for connection to a member requiring rotational movement.

5. The magnetic motor of claim 1 wherein said magnets on said magnet supports are selectively removably mounted on said magnet supports.

6. The magnetic motor of claim 1 wherein said magnet bars are selectively removably secured to said slide panels.

7. The magnetic motor of claim 1 wherein said magnet supports extend outwardly and laterally from said drive shaft and wherein said outer surfaces thereof are disposed at an angle with respect thereto.

8. The magnetic motor of claim 7 wherein said outer surfaces of said magnets on said magnet supports are angularly disposed with respect to said inside surfaces of said slide panels and are angularly disposed with respect to said outer planar surfaces of said magnet bars.

9. The magnetic motor of claim 8 wherein said outer surfaces of said magnet bars are angularly disposed with respect to said slide panels.

10. The magnetic motor of claim 1 wherein said outer surfaces of said magnets on said magnet supports are angularly disposed with respect to said planar outer surfaces of said magnet bars.

11. The magnetic motor of claim 1 wherein said frame means includes transversely extending slide bars upon which said slide panels are slidably movable.

12. The magnetic motor of claim 11 wherein said slide bars include resilient means thereon which yieldably resist the outward movement of said slide panels with respect to said frame means.

13. The magnetic motor of claim 1 wherein said magnets on said magnet supports are arranged on said drive shaft in a multiple helical manner.

14. The magnetic motor of claim 1 wherein said actuators comprise a power cylinder.

15. The magnetic motor of claim 1 wherein said magnets on said magnet supports are plate-like and have a planer outer surface.

16. The magnetic motor of claim 1 wherein said magnet bars have a planar outer face.

17. A magnetic motor, comprising:
an elongated hollow frame means having first and second ends;
a first bearing positioned at said first end of said frame means;
a second bearing positioned at said second end of said frame means;
an elongated first slide panel, having inner and outer sides and first and second ends, operatively movably secured to said frame means and positioned therein;
an elongated second slide panel, having inner and outer sides and first and second ends, operatively movable secured to said frame means and positioned therein opposite to said first slide panel;
each of said slide panels having a semi-circular cross-section;
a first actuator secured to and extending between said frame means and said first slide panel;
said first actuator adapted to move said first slide panel between a first outer position to a second inner position;
a second actuator secured to and extending between said frame means and said second slide panel;
said second actuator adapted to move said second slide panel between a first outer position to a second inner position;
an elongated drive shaft having first and second ends;
said drive shaft having its first and second ends being rotatably mounted in said first and second bearings, respectively;
a plurality of first elongated magnet supports having first and second ends;
said first magnet supports being secured at their said first ends to said drive shaft and extending outwardly therefrom;
said first magnet supports being secured to said drive shaft in a helical fashion with respect thereto;
a magnet secured to each of said second ends of said first magnet supports;
an elongated, semi-circular magnet positioned at said inner surface of said first slide panel;
an elongated, semi-circular magnet positioned at said inner surface of said second slide panel;
the polarity of said semi-circular magnets on said first and second slide panels and said magnets on said magnet supports being such that said magnets are repelled by said semi-circular magnets thereby causing said drive shaft to be rotated with respect to said frame means when said first and second actuators move said first and second slide panels from their said first outer position towards their said second inner position and towards said magnets on said magnet supports on said drive shaft.

18. The magnetic motor of claim 17 wherein said first end of said drive shaft has an adapter thereon for connection to a member requiring rotational movement.

19. The magnetic motor of claim 17 wherein said second end of said drive shaft has an adapter thereon for connection to a member requiring rotational movement.

20. The magnetic motor of claim 17 wherein each of said first and second ends of said drive shaft has an adapter thereon for connection to a member requiring rotational movement.

21. The magnetic motor of claim 17 wherein said magnets on said magnet supports are selectively removably mounted on said magnet supports.

22. The magnetic motor of claim 17 wherein said semi-circular magnets are selectively removably secured to said slide panels.

23. The magnetic motor of claim 17 wherein said magnet supports extend outwardly and laterally from said drive shaft and wherein said outer surfaces thereof are disposed at an angle with respect thereto.

24. The magnetic motor of claim 17 wherein said outer surfaces of said magnets on said magnet supports are angularly disposed with respect to said inside surfaces of said slide panels and are angularly disposed with respect to said outer surfaces of said semi-circular magnets.

25. The magnetic motor of claim 24 wherein said outer surfaces of said semi-circular magnets are angularly disposed with respect to said slide panels.

26. The magnetic motor of claim 17 wherein said outer surfaces of said magnets on said magnet supports are angularly disposed with respect to said outer surfaces of said semi-circular magnets.

27. The magnetic motor of claim 17 wherein said frame means includes transversely extending slide bars upon which said slide panels are slidably movable.

28. The magnetic motor of claim 27 wherein said slide bars include resilient means thereon which yieldably resist the outward movement of said slide panels with respect to said frame means.

29. The magnetic motor of claim 17 wherein said magnets on said magnet supports are arranged on said drive shaft in a multiple helical manner.

30. The magnetic motor of claim 17 wherein said actuators comprise a power cylinder.

31. The magnetic motor of claim 17 wherein said magnets on said magnet supports are plate-like and have a planar outer surface.
